(19) United States
(12) Patent Application Publication
(10) Pub. No.: US 2025/0083104 A1
(43) Pub. Date: Mar. 13, 2025

(54) LOW CONCENTRATION SINGLE PASS TANGENTIAL FLOW FILTRATION TO DE-BOTTLENECK CONNECTED AND/OR HIGH TITER FED BATCH PROCESSES

(71) Applicant: Genentech, Inc., South San Francisco, CA (US)

(72) Inventors: Molly Carpenter LIEN, San Francisco, CA (US); John Robert LAZZARESCHI, San Mateo, CA (US); Jerome Joseph BILL, JR., San Mateo, CA (US)

(21) Appl. No.: 18/826,764

(22) Filed: Sep. 6, 2024

Related U.S. Application Data
(60) Provisional application No. 63/581,556, filed on Sep. 8, 2023.

(51) Int. Cl. B01D 61/18; B01D 15/08; B01D 61/14

(52) U.S. Cl. CPC B01D 61/18; B01D 15/08; B01D 61/145; B01D 2315/10; B01D 2315/16; B01D 2317/02

(57) ABSTRACT

Exemplary systems and methods are provided for receiving a feed flow at a feed flow inlet of a single pass tangential flow filtration unit, wherein the single pass tangential flow filtration unit includes one or more membranes or membrane devices in a one-or two-stage configuration, and wherein a pressure drop across the one or more membranes or membrane devices is less than or equal to 30 psi. The systems and methods are configured to separate, using the one or more membranes or membrane devices in a one-or two-stage configuration, the feed stream into a permeate stream and a retentate stream and output the permeate stream through one or more permeate outlets and the retentate stream through one or more retentate outlets.

### CROSS REFERENCE TO RELATED APPLICATIONS

This application claims priority to U.S. Provisional Patent Application Ser. No. 63/581,556, filed Sep. 8, 2023, the entire contents of which are incorporated herein by reference.

### FIELD

The present disclosure relates generally to systems and methods for single pass tangential flow filtration (SPTFF) and specifically to modular one or two-stage SPTFF configurations with low pressure drops across the system.

### BACKGROUND

SPTFF is based on existing tangential flow filtration technology and is typically used for reducing volume and increasing concentration of a substance contained in a liquid, for instance a protein solution. Specifically, SPTFF is a filtration method that requires no recirculation and increases protein solution concentration by removing buffering solution as it flows across a semipermeable membrane while retaining product. SPTFF has been shown to be effective in reducing process volumes by 15-25× utilizing membranes configured serially, in parallel, or both.

High titer process development is creating constraints in manufacturing facilities as pool volumes are increasing to accommodate higher loading mass densities (for instance, affinity chromatography steps must run higher cycle counts to process the mass from high titer cell culture processes therefore creating larger pool volumes). Resulting pool volumes can exceed existing stainless steel tank sizes in facilities, leading to issues with facility fit. Additionally, processing of large volumes on subsequent process steps leads to increased run times, impacting plant productivity. Pool tank volumes can also be impacted by dilution and conditioning steps for a given process.

Existing solutions to facility fit constraints are often addressed on an ad hoc basis either through utilizing additional pool tanks at the impacted process step(s) or by implementing SPTFF using a traditional Ultrafiltration-Diafiltration/Tangential Flow Filtration (UFDF/TFF) skid in combination with traditional membranes commonly available. Additionally, many currently available SPTFF solutions aim for a high volumetric concentration factor, often greater than 5.0, and the resulting membrane area and membrane configurations required for the target concentration factor (typically at least 3-4 filter stages) results in high pressure drop across the filter membranes (e.g., greater than 30 psi). The volumetric concentration factor, as discussed throughout, is a function of the feed flow rate and the retentate flow rate.

Further, the magnitude of the pressure drop across the system under these operating conditions often prevents direct connection to a prior process step (e.g. chromatography column) to enable continuous processing. As such, the high target concentration factors and resulting high pressure drops across existing SPTFF solutions make connected and continuous processing difficult.

### SUMMARY

As such, a need exists for SPTFF systems and methods that can serve as modular (“plug and play”) systems to alleviate the manufacturing bottlenecks described above. The SPTFF systems and methods described herein are configured to increase protein solution concentration of a fluid by receiving a feed flow at one or more feed flow inlets/ports and directing the feed flow to one or more filter membranes configured to remove buffering solution as the fluid flows across the one or more semipermeable filter membranes while retaining product. The removed buffering solution is described throughout as the “permeate” and the product is described throughout as the “retentate.” As described, SPTFF systems are typically designed to achieve volumetric concentration factors, which is the ratio of retentate protein concentration to feed protein concentration, but which can be approximated by the retentate and feed flow rates, of greater than 5.0, and to achieve these high volumetric concentration factors, at least 3-4 filtration stages are typically required. In contrast, the systems and methods disclosed herein are designed for lower concentration factors (e.g., between 1.0 and 5.0), and thus require only one or two filtration stages. In some embodiments, SPTFF systems disclosed herein may include a 3:2 filter membrane configuration (i.e., the system may include two filtration stages, the first having three membranes and the second having two membranes), a 3:1 filter membrane configuration, or a 4:1 filter membrane configuration.

The one-or two-stage configuration can provide a reduced pressure drop across the system (from the feed flow inlet to the retentate outlet or retentate port) relative to a three to four stage configuration, providing for a modular SPTFF system that can be connected to various preceding and subsequent processes as required without the need for a feed pump or pool tank at the outlet of a preceding process. In other words, whereas existing SPTFF solutions are commonly configured as an independent operation with pool tanks on the inlet and outlet (rather than connected processes), a feed pump on the inlet of the SPTFF to control flow, and no pump on the permeate line, the SPTFF systems and methods disclosed herein may be configured such that the system can be readily inserted in-line with an existing purification system, such as a chromatography unit with no feed pump or pool tank provided therebetween. The systems disclosed herein may further be provided on a mobile cart, with minimum space requirements, such that the system can be readily transported to various connection points on an as-needed basis.

The SPTFF systems disclosed herein may include a tangential flow filtration device holder and corresponding membrane devices assembled into a one-or two-stage SPTFF configuration. The system may further include a variety of sensors, including pressure sensors, flow meters, temperature sensors, and so on, placed on one or more feed lines, permeate lines, and/or retentate lines. A feed line may be configured to transmit a feed stream from preceding system to a feed inlet on the SPTFF system, and the retentate lines may be respectively configured to receive the retentate from respective retentate outlets and transmit the retentate to various subsequent systems. Additionally, the SPTFF system may, in some examples, include various other components, including valves, clamps, or pumps provided on any of the feed, retentate, or permeate lines.

According to an aspect, a single pass tangential flow filtration system comprises: a single pass tangential flow filtration unit configured to be fluidly connected to one or more preceding systems and one or more subsequent systems, wherein: the single pass tangential flow filtration unit comprises one or more membranes or membrane devices in a one-or two-stage configuration, and a pressure drop across the one or more membranes or membrane devices is less than or equal to 30 psi.

In some embodiments, the pressure drop across the one or more membranes or membrane devices is less than 20 psi.

In some embodiments, the single pass tangential flow filtration unit is configured to be connected to the one or more preceding systems by a feed flow inlet configured to receive a feed stream. In some embodiments, no pump is provided between the single pass tangential flow filtration unit and the one or more preceding systems.

In some embodiments, the single pass tangential flow filtration unit is configured to be connected to the one or more subsequent systems by one or more retentate flow outlets each configured to output a retentate stream.

In some embodiments, the system is positioned on a mobile platform.

In some embodiments, the system further comprises a controller in electrical communication with one or more sensors, the one or more sensors provided on a feed line in fluid communication with the feed flow inlet, one or more permeate lines in fluid communication with the one or more permeate outlets, and one or more retentate lines in fluid communication with the one or more retentate outlets.

In some embodiments, the controller is configured to control a volumetric concentration factor based on a determined volumetric concentration factor.

In some embodiments, the volumetric concentration factor is determined based on a reading from a first sensor and a second sensor of the one or more sensors.

In some embodiments, the first sensor is a flow meter provided on the feed line in fluid communication with the feed flow inlet and the second sensor is a flow meter provided a retentate flow line of one or more retentate flow lines in fluid communication with one or more of the retentate outlets.

In some embodiments, the volumetric concentration factor is determined based upon a ratio of a measured flow rate of the feed stream to a measured flow rate of the retentate stream, wherein the respective flow rates are measured by the first and second sensors.

In some embodiments, the first sensor is a protein concentration sensor provided on the feed line in fluid communication with the feed flow inlet and the second sensor is a protein concentration sensor provided a retentate flow line of one or more retentate flow lines in fluid communication with one or more of the retentate outlets, and wherein the volumetric concentration factor is determined based upon a ratio of a measured protein concentration of the retentate stream to a measured protein concentration of the feed stream, wherein the respective protein concentrations are measured by the first and second sensors.

In some embodiments, controlling the volumetric concentration factor comprises: in accordance with determining that the volumetric concentration factor is outside of a threshold range based on the determined volumetric concentration factor, adjusting a flow rate of the permeate stream to bring the volumetric concentration factor within the threshold range. In some embodiments, adjusting a flow rate of the permeate stream can achieve a VCF and a resulting protein concentration which is desired for protein stability and/or downstream purification step performance.

In some embodiments, the threshold range is between 1.0 and 3.0, including 1.0 and 3.0.

In some embodiments, the threshold range is between 1.5 and 2.5, including 1.5 and 2.5.

In some embodiments, adjusting a flow rate of the permeate stream to bring the volumetric concentration factor within the threshold range comprises: activating or deactivating one or more permeate control pumps provided on one or more of the one or more permeate lines downstream of the one or more permeate outlets.

In some embodiments, one or more of the permeate control pumps include one or more variable displacement pumps.

In some embodiments, adjusting a flow rate of the permeate stream to bring the volumetric concentration factor within the threshold range comprises increasing a displacement of a variable displacement pump of the one or more variable displacement pumps.

In some embodiments, adjusting a flow rate of the permeate stream to bring the volumetric concentration factor within the threshold range comprises decreasing a displacement of a variable displacement pump of the one or more variable displacement pumps.

In some embodiments, one or more of the permeate control pumps include one or more fixed displacement pumps.

In some embodiments, adjusting a flow rate of the permeate stream to bring the volumetric concentration factor within the threshold range comprises: adjusting a valve provided on one or more permeate lines downstream of the one or more permeate outlets.

In some embodiments, adjusting the valve comprises opening the valve.

In some embodiments, adjusting the valve comprises closing the valve.

In some embodiments, the one or more sensors comprise a flow meter, a pressure sensor, a temperature sensor, and a protein concentration sensor.

In some embodiments, the single pass tangential flow filtration unit comprises one or more membranes or membrane devices in a one stage configuration.

In some embodiments, the one stage configuration is configured to receive a feed stream from the feed flow inlet and separate the feed stream into a retentate stream and a permeate stream by allowing a portion of the feed stream to pass through one or more membranes or membrane devices, the portion passing through the one or more membranes or membrane devices forming the permeate stream.

In some embodiments, the single pass tangential flow filtration unit comprises one or more membranes or membrane devices in a two-stage configuration.

In some embodiments, the two-stage configuration is configured to receive a feed stream from the feed flow inlet and separate the feed stream into a retentate stream and a permeate stream by allowing a portion of the feed stream to pass through one or more membranes or membrane devices of a first stage and one or more membranes or membrane devices of a second filtration stage, the portion passing through the one or more membranes of the first and second stage forming the permeate stream.

In some embodiments, the operating temperature of the feed stream is between 2 degrees Celsius and 30 degrees Celsius, including 2 degrees Celsius and 30 degrees Celsius.

In some embodiments, the operating temperature of the feed stream is less than or equal to 20 degrees Celsius.

In some embodiments, the operating temperature of the feed stream is less than or equal to 15 degrees Celsius.

In some embodiments, the operating temperature of the feed stream is less than or equal to 10 degrees Celsius.

In some embodiments, the operating temperature of the feed stream is less than or equal to 5 degrees Celsius.

In some embodiments, the operating temperature of the feed stream is between 1 degree Celsius and 3 degrees Celsius, including 1 degree Celsius and 3 degrees Celsius.

In some embodiments, the one or more preceding systems comprise a purification system or a harvest system.

In some embodiments, the purification system comprises a viral filtration system.

In some embodiments, the purification system comprises a chromatography system.

In some embodiments, the purification system comprises a diafiltration system.

In some embodiments, the purification system comprises an ultrafiltration system.

In some embodiments, the one or more subsequent systems comprise a purification system.

In some embodiments, the one or more subsequent systems comprise a viral filtration system.

In some embodiments, the one or more subsequent systems comprise a chromatography system.

In some embodiments, the one or more subsequent systems comprise a diafiltration system.

In some embodiments, the one or more subsequent systems comprise an ultrafiltration system.

In some embodiments, the feed flow comprises a polypeptide preparation.

In some embodiments, the polypeptide preparation comprises a polypeptide and one or more impurities.

In some aspects, an exemplary single pass tangential flow filtration method comprises: receiving a feed flow at a feed flow inlet of a single pass tangential flow filtration unit, wherein the single pass tangential flow filtration unit comprises one or more membranes or membrane devices in a one-or two-stage configuration, and wherein a pressure drop across the one or more membranes or membrane devices is less than or equal to 30 psi; separating, using the one or more membranes or membrane devices, the feed stream into a permeate stream and a retentate stream; and outputting the permeate stream through one or more permeate outlets and the retentate stream through one or more retentate outlets.

In some embodiments, the pressure drop across the one or more membranes or membrane devices is less than 20 psi.

In some embodiments, the single pass tangential flow filtration unit is configured to be connected to the one or more preceding systems by a feed flow inlet configured to receive a feed stream. In some embodiments, no pump is provided between the single pass tangential flow filtration unit and the one or more preceding systems.

In some embodiments, the single pass tangential flow filtration unit is configured to be connected to the one or more subsequent systems by one or more retentate flow outlets each configured to output a retentate stream.

In some embodiments, the single pass tangential flow filtration unit is positioned on a mobile platform.

In some embodiments, an exemplary system performing the method comprises a controller in electrical communication with one or more sensors, the one or more sensors provided on a feed line in fluid communication with the feed flow inlet, one or more permeate lines in fluid communication with the one or more permeate outlets, and one or more retentate lines in fluid communication with the one or more retentate outlets.

In some embodiments, the method further comprises controlling a volumetric concentration factor based on a determined volumetric concentration factor. In some embodiments, the volumetric concentration factor is determined based on a reading from a first sensor and a second sensor. In some embodiments, the first sensor is a flow meter provided on the feed line in fluid communication with the feed flow inlet and the second sensor is a flow meter provided a retentate flow line of one or more retentate flow lines in fluid communication with one or more of the retentate outlets. In some embodiments, the volumetric concentration factor is determined based upon a ratio of a measured flow rate of the feed stream to a measured flow rate of the retentate stream, wherein the respective flow rates are measured by the first and second sensors. In some embodiments, the first sensor is a protein concentration sensor provided on the feed line in fluid communication with the feed flow inlet and the second sensor is a protein concentration sensor provided a retentate flow line of one or more retentate flow lines in fluid communication with one or more of the retentate outlets, and wherein the volumetric concentration factor is determined based upon a ratio of a measured protein concentration of the retentate stream to a measured protein concentration of the feed stream, wherein the respective protein concentrations are measured by the first and second sensors.

In some embodiments, controlling the volumetric concentration factor comprises: in accordance with determining that the volumetric concentration factor is outside of a threshold range based on the determined volumetric concentration factor, adjusting a flow rate of the permeate stream to bring the volumetric concentration factor within the threshold range. In some embodiments, the threshold range is between 1.0 and 3.0, including 1.0 and 3.0. In some embodiments, the threshold range is between 1.5 and 2.5, including 1.5 and 2.5. In some embodiments, adjusting a flow rate of the permeate stream to bring the volumetric concentration factor within the threshold range comprises: activating or deactivating one or more permeate control pumps provided on one or more of the one or more permeate lines downstream of the one or more permeate outlets. In some embodiments, one or more of the permeate control pumps include one or more variable displacement pumps. In some embodiments, adjusting a flow rate of the permeate stream to bring the volumetric concentration factor within the threshold range comprises increasing a displacement of a variable displacement pump of the one or more variable displacement pumps. In some embodiments, adjusting a flow rate of the permeate stream to bring the volumetric concentration factor within the threshold range comprises decreasing a displacement of a variable displacement pump of the one or more variable displacement pumps. In some embodiments, one or more of the permeate control pumps include one or more fixed displacement pumps. In some embodiments, adjusting a flow rate of the permeate stream to bring the volumetric concentration factor within the threshold range comprises: adjusting a valve provided on one or more permeate lines downstream of the one or more permeate outlets. In some embodiments, adjusting the valve comprises opening the valve. In some embodiments, adjusting the valve comprises closing the valve. In some embodiments, the one or more sensors comprise a flow meter, a pressure sensor, a temperature sensor, and a protein concentration sensor. In some embodiments, adjusting a flow rate of the permeate stream can achieve a VCF and a resulting protein concentration which is desired for protein stability and/or downstream purification step performance.

In some embodiments, the single pass tangential flow filtration unit comprises one or more membranes or membrane devices in a one stage configuration. In some embodiments, the method further comprises receiving, by the one stage configuration, a feed stream from the feed flow inlet and separating the feed stream into a retentate stream and a permeate stream by allowing a portion of the feed stream to pass through one or more membranes or membrane devices, the portion passing through the one or more membranes or membrane devices forming the permeate stream.

In some embodiments, the single pass tangential flow filtration unit comprises one or more membranes or membrane devices in a two-stage configuration. In some embodiments, the method further comprises receiving by the two-stage configuration, a feed stream from the feed flow inlet and separating the feed stream into a retentate stream and a permeate stream by allowing a portion of the feed stream to pass through one or more membranes or membrane devices of a first stage and one or more membranes or membrane devices of a second filtration stage, the portion passing through the one or more membranes of the first and second stage forming the permeate stream.

In some embodiments, the operating temperature of the feed stream is between 2 degrees Celsius and 30 degrees Celsius, including 2 degrees Celsius and 30 degrees Celsius. In some embodiments, the operating temperature of the feed stream is less than or equal to 20 degrees Celsius. In some embodiments, the operating temperature of the feed stream is less than or equal to 15 degrees Celsius. In some embodiments, the operating temperature of the feed stream is less than or equal to 10 degrees Celsius. In some embodiments, the operating temperature of the feed stream is less than or equal to 5 degrees Celsius. In some embodiments, the operating temperature of the feed stream is between 1 degree Celsius and 3 degrees Celsius, including 1 degree Celsius and 3 degrees Celsius.

In some embodiments, the one or more preceding systems comprise a purification system or a harvest system. In some embodiments, the purification system comprises a viral filtration system. In some embodiments, the purification system comprises a chromatography system. In some embodiments, the purification system comprises a diafiltration system. In some embodiments, the purification system comprises an ultrafiltration system.

In some embodiments, the one or more subsequent systems comprise a purification system. In some embodiments, the one or more subsequent systems comprise a viral filtration system. In some embodiments, the one or more subsequent systems comprise a chromatography system. In some embodiments, the one or more subsequent systems comprise a diafiltration system. In some embodiments, the one or more subsequent systems comprise an ultrafiltration system.

In some embodiments, the feed flow comprises a polypeptide preparation. In some embodiments, the polypeptide preparation comprises a polypeptide and one or more impurities.

In some embodiments, any one or more of the characteristics of any one or more of the systems and methods recited above may be combined, in whole or in part, with one another and/or with any other features or characteristics described elsewhere herein.

### BRIEF DESCRIPTION OF THE FIGURES

FIG. 1 illustrates an exemplary single pass tangential flow filtration system, in accordance with some embodiments.

FIG. 2 illustrates an exemplary single pass tangential flow filtration system, in accordance with some embodiments.

FIG. 3 illustrates an exemplary single pass tangential flow filtration method, in accordance with some embodiments.

FIG. 4 illustrates an exemplary computing system, in accordance with some embodiments.

FIG. 5 illustrates data representing capabilities of exemplary two-stage configurations to concentrate load material in a single pass, in accordance with some embodiments.

FIG. 6 illustrates the VCF capabilities of different membranes arranged in a 3:2 membrane configuration, in accordance with some embodiments.

FIG. 7 illustrates an exemplary VCF range achieved by a two-stage 3:2 membrane configuration at two feed flux set points (100 LMH and 143 LMH) with low pressure drop (e.g., less than 20.0 psi) across the SPTFF system, in accordance with some embodiments.

FIG. 8 illustrates an exemplary plot of VCF values achieved by controlling permeate flux using a flow control device on the permeate line under fixed feed flux conditions, in accordance with some embodiments.

FIG. 9 illustrates an exemplary plot of VCF values achieved by controlling permeate flux using a flow control device on the permeate line under variable feed flux conditions, in accordance with some embodiments.

### DETAILED DESCRIPTION

Disclosed herein are modular systems and methods for single pass tangential flow filtration configured to achieve low pressure drop across the system that may be provided on mobile platforms such that the system can be readily transported to existing purification systems and connected in-line with those existing systems.

The following disclosure details exemplary embodiments of systems and methods for single pass tangential flow filtration (SPTFF). As described above, and as will be described in detail throughout, the systems and methods differ from existing systems in that the systems and methods disclosed herein achieve reduced pressure drop across the SPTFF system by implementing a one-or two-stage configuration rather than a three or four stage configuration. The systems and methods described herein are further configured to be modular such that the systems and methods can be incorporated in-line with existing systems, such as chromatography units, and may allow for control of volumetric concentration factor using various flow control mechanisms provided on permeate lines downstream of the membranes.

The SPTFF systems and methods described herein are configured to increase protein solution concentration of a fluid by receiving a feed flow at one or more feed flow inlets/ports and directing the feed flow to one or more filter membranes configured to remove buffering solution as the fluid flows across the one or more semipermeable filter membranes while retaining product. The removed buffering solution is described throughout as the “permeate” and the product is described throughout as the “retentate.” As described, SPTFF systems are typically designed to achieve volumetric concentration factors, which is the ratio of retentate protein concentration to feed protein concentration but which can be approximated by the retentate and feed flow rates, of greater than 5.0, and to achieve these high volumetric concentration factors, at least 3-4 filtration stages are typically required. In contrast, the systems and methods disclosed herein are designed for lower concentration factors (e.g., between 1.0 and 5.0), and thus require only one or two filtration stages. In some embodiments, SPTFF systems disclosed herein may include a 3:2 filter membrane configuration (i.e., the system may include two filtration stages, the first having three membranes and the second having two membranes), a 3:1 filter membrane configuration, or a 4:1 filter membrane configuration.

The one-or two-stage configuration can provide a reduced pressure drop across the system (from the feed flow inlet to the retentate outlet or retentate port) relative to a three to four stage configuration, providing for a modular SPTFF system that can be connected to various preceding and subsequent processes as required without the need for a feed pump or pool tank at the outlet of a preceding process. In other words, whereas existing SPTFF solutions are commonly configured as an independent operation with pool tanks on the inlet and outlet (rather than connected processes), a feed pump on the inlet of the SPTFF to control flow, and no pump on the permeate line, the SPTFF systems and methods disclosed herein may be configured such that the system can be readily inserted in-line with an existing purification system, such as a chromatography unit with no feed pump or pool tank provided therebetween. The systems disclosed herein may further be provided on a mobile cart, with minimum space requirements, such that the system can be readily transported to various connection points on an as-needed basis.

The SPTFF systems disclosed herein may include a tangential flow filtration device holder and corresponding membrane devices assembled into a one-or two-stage SPTFF configuration. The system may further include a variety of sensors, including pressure sensors, flow meters, temperature sensors, and so on, placed on one or more feed lines, permeate lines, and/or retentate lines. A feed line may be configured to transmit a feed stream from preceding system to a feed inlet on the SPTFF system, and the retentate lines may be respectively configured to receive the retentate from respective retentate outlets and transmit the retentate to various subsequent systems. Additionally, the SPTFF system may, in some examples, include various other components, including valves, clamps, or pumps provided on any of the feed, retentate, or permeate lines.

### Definitions

The term “configuration(s)” as used herein refers to a specific arrangement or staging of SPTFF devices.

The term “membrane device(s)” as used herein refers to devices such as capsules, cassettes, or modules in which membranes are provided.

The term “filter(s)” as used herein refers to a single or plurality of membranes which may make up a single filter unit.

The term “flow rate” as used herein refers to quantification of bulk fluid movement, the volume of fluid which passes per unit of time (for instance, Liters per minute).

The term “flux” as used herein refers to volumetric flow rate per unit area of membrane. Flow rate over total membrane area (for instance, Liters per meter squared per hour). Flux over a membrane is more indicative of performance than flow rate alone because it is normalized to the membrane area.

The term “membrane(s)” as used herein refers to the material over which filtration occurs. Membranes are defined by their molecular weight cut off (MWCO) and may be, for example, a flat sheet or hollow fiber format.

The term “system” as used herein to refer to the SPTFF system refers to the overall system, which includes the specific desired configuration of devices either on its own or within the broader family of the SPTFF housing and associated equipment to support operation.

The terms “comprising,” “having,” “containing,” and “including,” and other similar forms, and grammatical equivalents thereof, as used herein, are intended to be equivalent in meaning and to be open ended in that an item or items following any one of these words is not meant to be an exhaustive listing of such item or items, or meant to be limited to only the listed item or items. For example, an article “comprising” components A, B, and C can consist of (i.e., contain only) components A, B, and C, or can contain not only components A, B, and C but also one or more other components. As such, it is intended and understood that “comprises” and similar forms thereof, and grammatical equivalents thereof, include disclosure of embodiments of “consisting essentially of” or “consisting of.”

Where a range of values is provided, it is understood that each intervening value, to the tenth of the unit of the lower limit, unless the context clearly dictates otherwise, between the upper and lower limit of that range and any other stated or intervening value in that stated range, is encompassed within the disclosure, subject to any specifically excluded limit in the stated range. Where the stated range includes one or both of the limits, ranges excluding either or both of those included limits are also included in the disclosure.

Reference to “about” a value or parameter herein includes (and describes) variations that are directed to that value or parameter per se. For example, description referring to “about X” includes description of “X.”

As used herein, including in the appended claims, the singular forms “a,” “or,” and “the” include plural referents unless the context clearly dictates otherwise.

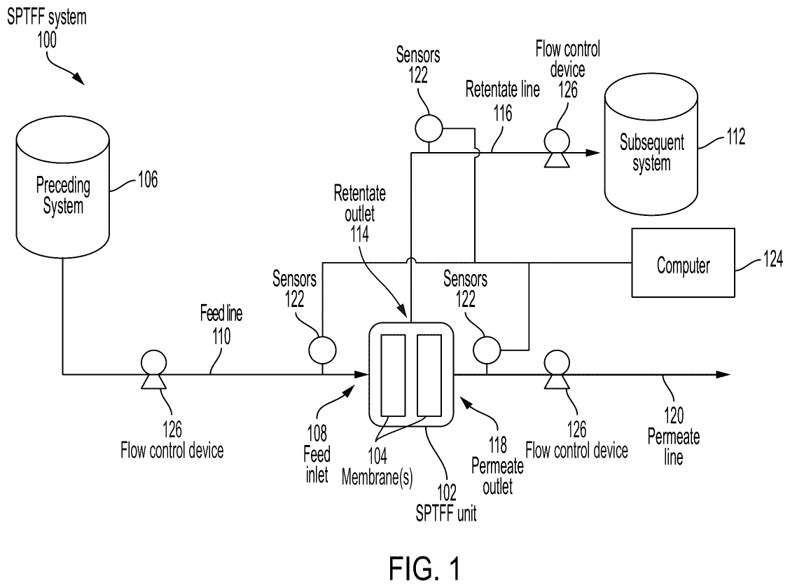

FIG. 1 illustrates an exemplary SPTFF system 100 in accordance with some embodiments. The exemplary system includes an SPTFF unit 102 comprising membrane(s) 104 in a one-or two-stage configuration. The membrane(s) 104 may be configured to receive a feed stream from a feed inlet 108 and separate the feed stream into a retentate stream and a permeate stream by allowing a portion of the feed stream to pass through one or more membrane(s) or membrane device(s) of the respective one-or two-stage configuration. For instance, after passing through the feed inlet 108, the feed stream may be separated into a permeate stream and a retentate stream by one or more membranes of a first stage, and/or one or more membranes of a second stage of SPTFF unit 102. The feed stream may be separated into the permeate and retentate streams throughout the length of the flow path within the one-or two-stage SPTFF unit 102 by allowing a portion of the feed stream to pass through a semi-permeable membrane. The portion passing through the membrane forms the permeate flow and the remainder forms the concentrated retentate.

The permeate stream may exit the SPTFF unit 102 via one or more permeate outlets 118 and the retentate flow may exit the SPTFF unit 102 via one or more retentate outlets 114. The permeate outlets 118 and retentate outlets 114 may be fluidly connected to one or more respective permeate lines 120 and one or more respective retentate lines 116. In some embodiments, the system 100 includes two permeate outlets 118 fluidly connected to a single permeate line 120. It should be understood that the number of inlets and outlets (e.g., feed inlets, retentate outlets, and permeate outlets) and the number of corresponding feed lines, retentate lines, and permeate lines could be adjusted to include any number of any of the respective inlets, outlets, and lines without deviating from the scope of the claims.

The SPTFF 102 unit may include a one-or two-stage configuration of membranes or membrane devices, and the membranes or membrane devices may be configured such that the pressure drop across the membranes or membrane devices is less than or equal to 30 psi. In some examples, the SPTFF unit 102 may be configured such that the pressure drop across the one-or two-stage configuration of membranes or membrane devices is less than or equal to 20 psi. In some examples, the SPTFF unit 102 may be configured such that the pressure drop across the one-or two-stage configuration is between 15 psi and 30 psi, inclusive. In some examples, the pressure drop across the one-or two-stage configuration may be between 15 psi and 20 psi, inclusive. In some examples, the pressure drop across the one-or two-stage configuration may be less than or equal to 15 psi. A pressure drop across the one-or two-stage configuration within the aforementioned pressure ranges may allow for configurations of the SPTFF system in which no feed pump is provided upstream of the feed inlet.

In some examples, the membranes have a nominal molecular weight limit of about 10 kD, about 30 kD or about 50 kD. In some examples, one or more of the respective membranes can have a different molecular weight than one or more of the other respective membranes (e.g., a 1:1:1 series be 10 kD:30 kD:30kD). In some examples, one or more of the membranes are narrow channel or wide channel membranes. In some examples, one or more of the membranes comprise a C screen or a D screen. In some examples, one or more of the membranes can be regenerated cellulose or PES. In some examples, one or more of the membranes are PELLICON XL membranes or SARTOCON HYDROSART® ECO membranes. In some examples, one or more of the membranes can be Pall membranes, Millipore membranes (e.g., Millipore A screens, C screens, D screens), Sartorius membranes, Repligen membranes (e.g., Repligen L screens, E screens), Centramate membranes, Delta membranes, Hydrosart, ECO, or any other membrane suitable to the SPTFF systems described herein.

In some examples, the feed stream comprises a polypeptide preparation, the preparation comprising a polypeptide and one or more impurities. The polypeptide may be an antibody, and the antibody may be a monoclonal antibody. In examples where the polypeptide is a monoclonal antibody, it may be an IgG monoclonal antibody. The antibody may be a human antibody, a humanized antibody, or a chimeric antibody. In some examples, the feed stream comprises an antibody-drug conjugate.

The antibody may be an antigen binding fragment. The antigen binding fragment may be a Fab fragment, a Fab′ fragment, a F(ab′)2 fragment, a scFv, a di-scFv, a bi-scFv, a tandem (di, tri)-scFv, a Fv, a sdAb, a tri-functional antibody, a BiTE, a diabody or a triabody. The antibody may be a bispecific antibody or bispecific antigen binding fragment thereof. The antibody may be selected from the group consisting of: an anti-TAU antibody, an anti-TGFβ3 antibody, an anti-CD20 antibody, an anti-CD40 antibody, an anti-HER2 antibody, an anti-IL6 antibody, an anti-IgE antibody, an anti-IL13 antibody, an anti-TIGIT antibody, an anti-PD-L1 antibody, an anti-VEGF-A antibody, an anti-VEGF-A/ANG2 antibody, an anti-CD79b antibody, an anti-ST2 antibody, an anti-factor D antibody, an anti-factor IX antibody, an anti-factor X antibody, an anti-abeta antibody, an anti-tau antibody, an anti-CEA antibody, an anti-CEA/CD3 antibody, an anti-CD20/CD3 antibody, an anti-FcRH5/CD3 antibody, an anti-Her2/CD3 antibody, an anti-FGFR1/KLB antibody, a FAP-4-1 BBL fusion protein, a FAP-IL2v fusion protein, and a TYRP1 TCB antibody.

The antibody may be selected from the group consisting of: ocrelizumab, pertuzumab, trastuzumab, tocilizumab, faricimab, polatuzumab, gantenerumab, cibisatamab, crenezumab, mosunetuzumab, tiragolumab, bevacizumab, rituximab, atezolizumab, obinutuzumab, lampalizumab, lebrikizumab, omalizumab ranibizumab, emicizumab, selicrelumab, prasinezumab, RO6874281, satrilizumab, and RO7122290.

In some examples, the one or more impurities may be any one or more of host cell protein (HCP), nucleic acids, polypeptide variants, polypeptide aggregates, polypeptide fragments, or cell culture media components. The polypeptide may be prepared in a Chinese hamster ovary (CHO) cell. The one or more impurities may be a Chinese hamster ovary cell protein (CHOP). The polypeptide may be prepared in an E. coli cell. The one or more impurities may be an E. coli protein (ECP).

In some examples, the SPTFF unit 102 can be fluidly connected to one or more preceding systems 106 at a feed inlet 108 via a feed line 110. The preceding system may include a purification system, for instance, a chromatography system, a diafiltration system, or an ultrafiltration system. The one or more preceding systems may include a harvest system. The one or more preceding systems may include one or more viral filtration systems. The SPTFF unit 102 may be directly connected to a preceding purification system, meaning there may be no pump provided on the feed line. As such, the SPTFF unit 102 can be readily connected in line with a variety of preceding systems without installation of a feed pump. However, if a feed pump is required, for instance, because an existing system is already configured to have a pool at the outlet of the upstream system, a feed pump can optionally be installed between the preceding system and the SPTFF unit 102.

In some examples, the SPTFF unit 102 can be connected to one or more subsequent systems 112 at one or more retentate outlets 114 via one or more retentate lines 116. As with the preceding system, the one or more subsequent systems may include one or more purification systems, for instance, a chromatography system, a diafiltration system, or an ultrafiltration system. The one or more subsequent systems may include one or more viral filtration systems.

The SPTFF unit 102 can be directly fluidly connected to the one or more subsequent systems at one or more retentate outlets 114 via one or more retentate lines 116, or indirectly connected to the one or more subsequent systems, for instance, if a pool is placed between the SPTFF unit retentate outlet and a subsequent purification system.

In some examples, one or more sensors 122 are provided on one or more of the feed line, one or more retentate lines, and one or more permeate lines. The sensors 122 may additionally or alternatively be provided on the SPTFF unit at one or more of the feed inlet/port, one or more retentate outlets/ports, and one or more permeate outlets/ports. The sensors 122 may include one or more flow meters, pressure sensors, temperature sensors, and protein concentration sensors for monitoring various characteristics of the feed stream, retentate stream, and permeate stream at different points throughout the system. For example, the one or more sensors may monitor characteristics of the respective streams (feed stream, retentate stream, permeate stream) at different locations throughout the system and over time, capturing information related to evolving flow characteristics. As described below, the monitored characteristics may be used for analytics related to system performance, maintenance planning, and/or used to trigger various alerts or control signals by a computer 124 comprising a controller (not shown) electrically connected to the one or more sensors. For instance, the one or more control signals may control the feed flow rate, retentate flow rate, and/or permeate flow rate by controlling one or more pumps, valves, or other flow control devices provided on the system as described throughout. In some examples, one or more retentate and permeate flow control devices work in tandem to control flow of the retentate and permeate streams at the correct ratio to achieve a concentration factor (e.g., a low feed flow rate condition that requires back pressure from the retentate control device to maintain positive pressure drop while permeate control maintains concentration factor ratio).

As noted immediately above, in some examples, the sensors 122 may be in electrical communication with a computer 124 (e.g., by one or more wired or wireless communication protocols), and the computer may be configured to transmit control signals via the one or more wired or wireless communication protocols to control various components of the system (e.g., pumps, valves, etc.). In some examples, the computer may be configured to receive input signals from one or more preceding systems and/or one or more subsequent systems and transmit control signals via the one or more wired or wireless communication protocols to control various components of the system (e.g., pumps, valves, etc.). The computer 124 may be configured to control a volumetric concentration factor (a ratio of feed flow rate to retentate flow rate) based on a determined volumetric concentration factor. The volumetric concentration factor may be determined based upon a ratio of the retentate stream protein concentration to feed stream protein concentration and/or by a ratio of the feed flow rate to the retentate flow rate.

The computer 124 may receive signals corresponding to either a measured flow rate or a measured protein concentration from one or more of the sensors 122 and determine, based on the signals from one or more of the sensors 122, a volumetric concentration factor. The signals may be transmitted to the computer 124 by a first sensor 122 provided on the feed line 110 and a second sensor 122 provided on a retentate line 116. The first and second sensors 122 may be flow meters and the signals may be measured flow rates of the feed stream and the retentate stream. Alternatively, the first and second sensors 122 may be protein concentration sensors and the signals may be measured protein concentrations of the feed stream and the retentate stream.

As such, according to one or more examples, a signal corresponding to the measured feed flow rate from the first sensor 122 provided on the feed line and a signal corresponding to the measured retentate flow rate from the second sensor 122 provided on the retentate flow line may be transmitted from the first and second sensors to the computer 124. According to one or more examples, a signal corresponding to the measured protein concentration of the feed flow from the first sensor 122 provided on the feed line and a signal corresponding to the measured protein concentration of the retentate flow from the second sensor 122 provided on the retentate flow line may be transmitted from the first and second sensors, respectively, to the computer 124. The computer 124 can then determine the volumetric concentration factor by determining the ratio of either the feed flow rate to the retentate flow rate or the retentate flow protein concentration to the feed flow protein concentration. Based on the determined volumetric concentration factor, the computer 124 may adjust a flow rate of the permeate flow by transmitting a signal to a flow control device 126 provided on the permeate line 120 if the determined volumetric concentration factor is outside of a predefined threshold range. In some examples, the computer 124 may adjust a flow rate of the retentate stream by transmitting a signal to a flow control device 126 provided on the retentate line 116, for instance, in response to a low feed flow rate condition that requires back pressure from the retentate control device to achieve target concentration.

In some examples, the systems described herein may determine a feed and retentate flux based on the measured feed and retentate flow rates, which may be used to determine the volumetric concentration factor by determining the ratio of feed flux to the retentate flux. As described above, the flux refers to volumetric flow rate per unit area of membrane, which may be more indicative of performance than flow rate alone because it is normalized to the membrane area.

The predefined threshold range of the volumetric concentration factor may be between any of 1.0 and 5.0, 1.0 and 4.5, 1.0 and 4.2, 1.0 and 4.0, 1.0 and 3.0, 1.2 and 2.5, 1.5 and 2.5, 1.6 and 2.5, 1.7 and 2.5, 1.8 and 2.5, 1.9 and 2.5, 2.0 and 2.5, 2.1 and 2.5, 2.2 and 2.5, 2.3 and 2.5, 2.4 and 2.5, 1.2 and 2.4, 1.5 and 2.4, 1.6 and 2.4, 1.7 and 2.4, 1.8 and 2.4, 1.9 and 2.4, 2.0 and 2.4, 2.1 and 2.4, 2.2 and 2.4, 2.3 and 2.4, 1.2 and 2.3, 1.5 and 2.3, 1.6 and 2.3, 1.7 and 2.3, 1.8 and 2.3, 1.9 and 2.3, 2.0 and 2.3, 2.1 and 2.3, 2.2 and 2.3, 1.2 and 2.2, 1.5 and 2.52 1.6 and 2.2, 1.7 and 2.2, 1.8 and 2.2, 1.9 and 2.2, 2.0 and 2.2, 2.1 and 2.2, 1.2 and 2.1, 1.5 and 2.1, 1.6 and 2.1, 1.7 and 2.1, 1.8 and 2.1, 1.9 and 2.1, 2.0 and 2.1, 1.2 and 2.0, 1.5 and 2.0, 1.6 and 2.0, 1.7 and 2.0, 1.8 and 2.0, 1.9 and 2.0, 1.2 and 1.9, 1.5 and 1.9, 1.6 and 1.9, 1.7 and 1.9, 1.8 and 1.9, 1.2 and 1.8, 1.5 and 1.8, 1.6 and 1.8, 1.7 and 1.8, 1.2 and 1.7, 1.5 and 1.7, 1.6 and 1.7, 1.2 and 1.6, 1.5 and 1.6, or 1.2 and 1.5. In some embodiments, the SPTFF operation achieves a VCF of any of about 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0.

As noted above, the computer 124 may adjust the flow rate of the permeate flow by transmitting a control signal to one or more flow control devices 126 provided on one or more permeate lines 120 in fluid communication with the one or more permeate outlets/ports 118 and/or one or more flow control devices 126 provided on one or more retentate lines 116 in in fluid communication with the one or more retentate outlets/ports 114. The flow control devices may be one or more pumps, for instance variable displacement or fixed displacement pumps. For example, the computer may adjust the permeate and/or retente flow rate by activating or deactivating one or more pumps or by increasing or decreasing the displacement of one or more variable displacement pumps. The one or more flow control devices could also be valves or clamps, and the computer may adjust the flow rate of the permeate and/or retentate flow rate by opening or closing (fully or partially) one or more of the one or more valves or clamps.

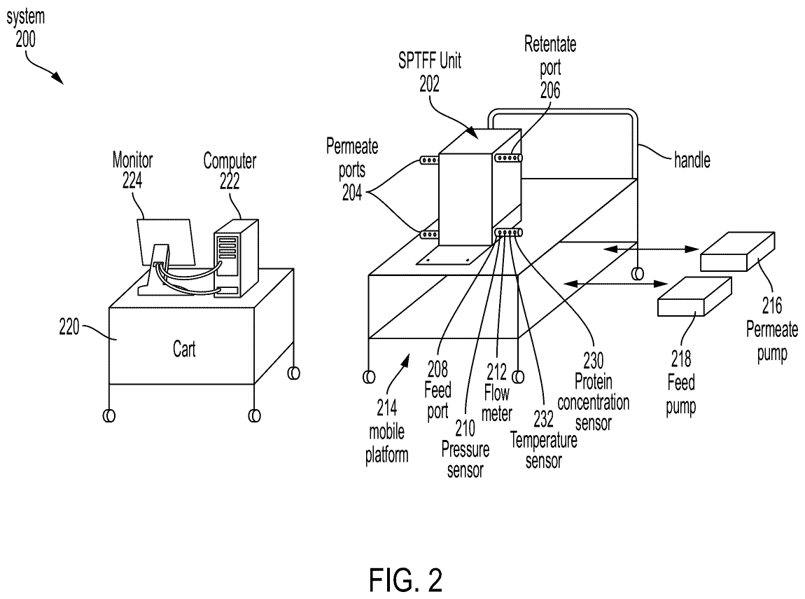

FIG. 2 illustrates an exemplary SPTFF system 200 in accordance with some embodiments comprising an SPTFF unit 202, the SPTFF unit 202 comprising two permeate ports 204, a retentate port 206, and a feed port 208. A feed stream may be received at the feed port 208. The feed stream may be received from one or more preceding systems, including any of the preceding systems described above with reference to FIG. 1. After passing through the feed port 208, the feed stream may be separated into permeate and retentate streams by one or more membranes or membrane devices of a one-or two-stage SPTFF system 200. The feed stream may be separated into the permeate and retentate streams throughout the length of the flow path along the membranes or membrane devices by allowing a portion of the feed stream to pass through one or more semi-permeable membranes included in each respective stage. The portion passing through the one or more membranes forms the permeate stream and the remainder forms the concentrated retentate stream. The permeate stream may exit the SPTFF unit 202 via the two permeate ports 204 and the retentate stream may exit the SPTFF unit 202 via the retentate port 206. The permeate ports 204 and retentate port 206 may be fluidly connected to one or more permeate lines (such as the permeate lines 120 described with reference to FIG. 1) and one or more retentate lines (such as the retentate lines 116 described with reference to FIG. 1). It should be understood that the number of ports (e.g., one feed port, one retentate port, and two permeate ports) and the number of corresponding feed lines, retentate lines, and permeate lines could be adjusted to include any number of any of the respective ports without deviating from the scope of the claims.

A pressure sensor 210, flow meter 212, protein concentration sensor 230, and temperature sensor 232 can be provided at each port (e.g., the feed port 208, first and second permeate ports 204, and retentate port 206) of the exemplary SPTFF unit 202. The pressure sensors 210 may be used for monitoring a pressure drop across the membrane or membrane devices. The flow meters 212 and protein concentrations sensors 230 may be used for determining volumetric concentration factors, for instance, as described above regarding FIG. 1. As such, a first signal may be transmitted to the computer 222 from a first flow meter 212 provided at the feed port 208 and a second signal may be transmitted to the computer 222 from a second flow meter 212 provided at the retentate port 206. The first and second signals may be measured flow rates of the feed stream and the retentate stream, and the computer 222 may determine based upon measured flow rates of the feed stream and the retentate stream, a volumetric concentration factor.

Alternatively, or additionally, a first signal may be transmitted to computer 222 from a first protein concentration sensor 230 provided at the feed port 208, and a second signal may be transmitted to the computer 222 from a second protein sensor 230 provided at the retentate port 206, wherein the signals may be measured protein concentrations of the feed stream and the retentate stream. The computer 222 may determine, based upon the measured protein concentrations of the feed stream and the retentate stream, a volumetric concentration factor. As such, similarly to the system 100 described with reference to FIG. 1, the system 200 may determine a volumetric concentration factor using either or both the measured flow rates of the retentate and feed flow or the measured protein concentrations of the retentate and feed streams. Based on the determined volumetric concentration factor, the computer 222 may adjust a flow rate of the permeate flow by transmitting a signal to a flow control device (e.g., flow control device 126 of the system 100) provided on a permeate line (e.g., permeate line 120 of the system 100) if the determined volumetric concentration factor is outside of a predefined threshold range.

The predefined threshold range of the volumetric concentration factor may include any of the ranges described above with reference to FIG. 1. As such, the predefined threshold range of the volumetric concentration factor may be between any of 1.0 and 5.0, 1.0 and 4.5, 1.0 and 4.2, 1.0 and 4.0, 1.0 and 3.0, 1.2 and 2.5, 1.5 and 2.5, 1.6 and 2.5, 1.7 and 2.5, 1.8 and 2.5, 1.9 and 2.5, 2.0 and 2.5, 2.1 and 2.5, 2.2 and 2.5, 2.3 and 2.5, 2.4 and 2.5, 1.2 and 2.4, 1.5 and 2.4, 1.6 and 2.4, 1.7 and 2.4, 1.8 and 2.4, 1.9 and 2.4, 2.0 and 2.4, 2.1 and 2.4, 2.2 and 2.4, 2.3 and 2.4, 1.2 and 2.3, 1.5 and 2.3, 1.6 and 2.3, 1.7 and 2.3, 1.8 and 2.3, 1.9 and 2.3, 2.0 and 2.3, 2.1 and 2.3, 2.2 and 2.3, 1.2 and 2.2, 1.5 and 2.52 1.6 and 2.2, 1.7 and 2.2, 1.8 and 2.2, 1.9 and 2.2, 2.0 and 2.2, 2.1 and 2.2, 1.2 and 2.1, 1.5 and 2.1, 1.6 and 2.1, 1.7 and 2.1, 1.8 and 2.1, 1.9 and 2.1, 2.0 and 2.1, 1.2 and 2.0, 1.5 and 2.0, 1.6 and 2.0, 1.7 and 2.0, 1.8 and 2.0, 1.9 and 2.0, 1.2 and 1.9, 1.5 and 1.9, 1.6 and 1.9, 1.7 and 1.9, 1.8 and 1.9, 1.2 and 1.8, 1.5 and 1.8, 1.6 and 1.8, 1.7 and 1.8, 1.2 and 1.7, 1.5 and 1.7, 1.6 and 1.7, 1.2 and 1.6, 1.5 and 1.6, or 1.2 and 1.5. In some embodiments, the SPTFF operation achieves a VCF of any of about 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0.

The computer 222 may adjust the flow rate of the permeate stream and or retentate stream by transmitting a control signal to one or more flow control devices (e.g., a control device 126 as described with reference to FIG. 1) provided on one or more permeate lines in fluid communication with the one or more permeate outlets/ports 204 and or one or more flow control devices (e.g., a control device 126 as described with reference to FIG. 1) provided on the retentate outlet/port 206. The flow control devices may be one or more pumps, for instance variable displacement or fixed displacement pumps. For example, the computer may adjust the permeate flow rate by activating or deactivating one or more permeate control pumps or by increasing or decreasing the displacement of a variable displacement pump. The one or more flow control devices could also be valves or clamps, and the computer may adjust the flow rate of the permeate stream by opening or closing (fully or partially) one or more of the one or more valves or clamps.

The SPTFF unit 202 illustrated in FIG. 2 is provided on a mobile platform 214, and the mobile platform 214 can be configured to mount both a permeate pump 216 and a feed pump 218. The permeate pump 216 can be fluidly connected to the SPTFF unit via the permeate port (e.g., fluidly connected to a permeate line in fluid communication with the permeate port). When activated, the permeate pump may increase a flow rate of the permeate flow by drawing flow from the feed stream into the permeate stream, thus effecting a change in the volumetric concentration factor. As such, the permeate pump 216 may be used to adjust a flow rate of the permeate flow to control the volumetric concentration factor to ensure that the volumetric concentration factor remains within a predefined threshold range.

As described, in some embodiments, no feed pump is included as part of the SPTFF systems and methods disclosed herein. In such embodiments, the SPTFF unit 202 can be directly connected to an outlet of a preceding system (e.g., preceding purification step), and the flow at the outlet of the preceding system drives the feed flow of the SPTFF unit 202. However, in some embodiments, a feed pump 218 may optionally be included as part of the SPTFF system if a feed pump is needed to generate a feed flow, for instance, if a preceding system to which the exemplary SPTFF system is connected to a pool, intermediate vessel, surge vessel, mixing tank, bubble trap, etc. from which a feed pump must be used to generate a feed flow to the SPTFF unit. The feed pump may be fluidly connected to the SPTFF unit via the feed port 208 (e.g., fluidly connected to a feed line in fluid communication with the feed port). In some examples, if one or both of the feed pump and permeate pumps are not needed for a given application of the SPTFF unit, then additional data collection/processing units may be provided on the mobile platform 214 in place of the feed pump and/or permeate pump.

The SPTFF system 200 may include a cart 220 accompanying the SPTFF unit 202. The cart 220 may house supplemental computers 222 and monitors 224 for data visualization and analytics and/or control of various components of the system 200. As shown in FIG. 2, the cart 220 may include a pressure monitor for displaying a visualization of the pressure readings acquired by the pressure sensors 210. The supplemental computers 222 and monitors 224 for data visualization and analytics and/or control of various components of the system 200 included on the cart 220 may be configured for monitoring and/or controlling pressure, flow rate, and/or protein concentration of the flow (e.g., feed flow, retentate flow, permeate flow) at various points in the system. The supplemental computers 222 may be configured to generate alerts/alarms or cause the system to automatically shut down based on a flow rate, pressure, or volumetric concentration factor of the system. For instance, a user or system operator may set a pressure, flow rate, temperature, protein concentration, and/or volumetric concentration factor threshold (e.g., via input device 406), and supplemental computers 222 (and/or computer 124) may be configured to generate alerts/alarms and/or cause the system to shut shown if the pressure, flow, rate or volumetric concentration factor exceeds and/or falls below the set threshold.

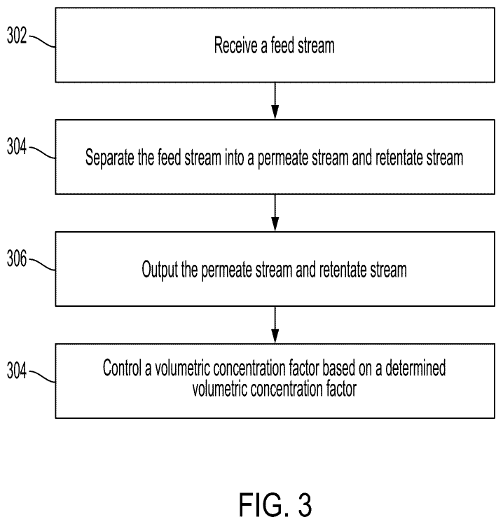

FIG. 3 illustrates an exemplary method 300 for single pass tangential flow filtration, in accordance with some embodiments. The method 300 may be implemented using, for instance, the SPTFF system 100 or 200 described above with reference to FIGS. 1 and 2. In some examples, the method 300 may begin at step 302, wherein step 302 comprises receiving a feed stream at a feed inlet of an SPTFF unit (for instance, SPTFF unit 102 or 202 described above). The feed stream may include any of the exemplary polypeptide preparations noted above with reference to FIG. 1.

The SPTFF unit may include a one-or two-stage configuration of membranes or membrane devices, and the membranes or membrane devices may be configured such that the pressure drop across the membranes or membrane devices is less than or equal to 30 psi. In some examples, the SPTFF unit 102 may be configured such that the pressure drop across the one-or two-stage configuration of membranes or membrane devices is less than or equal to 20 psi. In some examples, the SPTFF unit 102 may be configured such that the pressure drop across the one-or two-stage configuration is between 15 psi and 30 psi, inclusive. In some examples, the pressure drop across the one-or two-stage configuration may be between 15 psi and 20 psi, inclusive. In some examples, the pressure drop across the one-or two-stage configuration may be less than or equal to 15 psi. A pressure drop across the one-or two-stage configuration within the aforementioned pressure ranges may allow for configurations of the SPTFF system in which no feed pump is provided upstream of the feed inlet.

The SPTFF unit can be positioned on a mobile platform such that the SPTFF unit can be transported to various connection points and connected in-line between various preceding and subsequent purification systems. The SPTFF unit may be configured to be connected to the one or more preceding systems by fluidly connecting the one or more preceding systems to the SPTFF unit via the feed inlet. In some embodiments, the SPTFF unit is connected to one or more subsequent systems by one or more retentate outlets. In some embodiments, each respective retentate outlet is configured to output a retentate stream. In some embodiments, the SPTFF unit is connected to a waste disposal by one or more permeate outlets, the permeate outlets being configured to output a permeate stream.

As noted above with respect to FIG. 1, the one or more preceding systems may include a purification system, for instance, a chromatography system, a diafiltration system, an ultrafiltration system, or a viral filtration system. In some examples, the one or more preceding systems may include a harvest system. Similarly, the one or more subsequent systems may also comprise a purification system, including a chromatography system, a diafiltration system, an ultrafiltration system, or a viral filtration system.

After receiving a feed stream at step 302, the method 300 may proceed to step 304, wherein step 304 includes separating, using the one-or two-stage configuration of the SPTFF unit, the feed flow into a permeate stream and a retentate stream. In some embodiments where the SPTFF unit includes a one stage configuration of membranes or membrane devices, one stage SPTFF unit can be configured to receive a feed stream from the feed inlet and separate the feed stream into a retentate stream and a permeate stream by allowing a portion of the feed stream to pass through one or more membranes or membrane devices of the single filtration stage. As such, the portion passing through the one or more membranes or membrane devices forms the permeate and the portion not passing through the one or more membranes or membrane devices becomes the retentate. In some examples, where the SPTFF unit includes two stages, comprising a first stage and a second stage, the SPTFF unit is configured to receive a feed stream from the feed inlet and separate the feed stream into a retentate stream and a permeate stream by allowing a portion of the feed stream to pass through one or more membranes or membrane devices of the first stage and one or more membranes or membrane devices of the second stage. As such, the portion passing through the one or more membranes or membrane devices of the first and second stage forms the permeate and the portion not passing through the one or more membranes becomes the retentate.

After separating, using the one-or two-stage configuration of the SPTFF unit, the feed flow into a permeate stream and a retentate stream at step 304, the method 300 may proceed to step 306, wherein step 306 includes outputting the permeate through one or more permeate outlets and outputting the retentate through one or more retentate outlets.

In some examples, after outputting the permeate through one or more permeate outlets and the retentate through one or more retentate outlets at step 306, the method 300 may proceed to step 308, wherein step 308 includes controlling a volumetric concentration factor based on a determined volumetric concentration factor. As described above with reference to FIGS. 1 and 2, one or more sensors in electrical communication with a controller may be provided on the SPTFF unit (e.g., on each of the feed ports, retentate ports, and permeate ports) and/or on one or more fluid lines (e.g., feed lines, retentate lines, permeate lines) connected to the SPTFF unit. The sensors may include flow meters, pressure tensors, temperature sensors, and protein concentration sensors among other sensors configured to collect data associated with various aspects of the method 300.

The controller may be configured to control a volumetric concentration factor based on a determined volumetric concentration factor, wherein the volumetric concentration factor is determined based on a reading from a first sensor and a second sensor of the one or more sensors. The first sensor may be a flow meter provided on the feed line in fluid communication with the feed inlet and the second sensor may be a flow meter provided a retentate flow line of one or more retentate flow lines in fluid communication with one or more of the retentate outlets. The volumetric concentration factor can be determined based on a ratio of a measured flow rate of the feed stream to a measured flow rate of the retentate stream, wherein the respective flow rates are measured by the first and second sensors, and thus, the volumetric concentration factor can be adjusted by adjusting the flow rate of the permeate stream. Alternatively, or additionally, the volumetric concentration factor can be determined based on a ratio of a measured feed stream protein concentration to the measured retentate stream protein concentration.

The controller may receive signals corresponding to either a measured flow rate or a measured protein concentration from one or more of the sensors (e.g., sensors 122 described above with reference to FIG. 1) and determine, based on the signals from one or more of the sensors, a volumetric concentration factor. The signals may be transmitted by a first sensor provided on a feed line and a second sensor provided on a retentate line. As described above, the first and second sensors may be flow meters and the signals may be measured flow rates of the feed stream and the retentate stream. Alternatively, the first and second sensors may be protein concentration sensors and the signals may be measured protein concentrations of the feed stream and the retentate stream.

As such, according to one or more examples, a signal corresponding to the measured feed flow rate from the first sensor provided on the feed line and a signal corresponding to the measured retentate flow rate from the second sensor provided on the retentate flow line may be transmitted from the first and second sensors to the controller. According to one or more examples, a signal corresponding to the measured protein concentration of the feed stream from the first sensor provided on the feed line and a signal corresponding to the measured protein concentration of the retentate stream from the second sensor provided on the retentate flow line may be transmitted from the first and second sensors, respectively, to the controller. The controller can then determine the volumetric concentration factor by determining the ratio of either the feed flow rate to the retentate flow rate or the retentate stream protein concentration to the feed stream protein concentration. Based on the determined volumetric concentration factor, the controller may adjust a flow rate of the permeate flow by transmitting a signal to a flow control device (e.g., flow control device 126 as discussed above with reference to FIG. 1) provided on the permeate line if the determined volumetric concentration factor is outside of a predefined threshold range. In some embodiments, the predefined threshold range may be set by a user or operator of the system, for instance, via an input device (e.g., input device 406) in communication with computer 124. As described above, thresholds associated with other flow characteristics, such as flow rate, protein concentration, temperature, and/or pressure, may also be set, and various control signals may automatically be transmitted to system components and/or alerts may automatically be generated if flow rate, protein concentration, temperature, volumetric concentration factor, and/or pressure exceeds or falls below the set threshold. Further, as described above, one or more flow control devices may also be provided on one or more of the retentate lines and controlled by a signal transmitted to the flow control device.

The threshold range may be between any of 1.0 and 5.0, 1.0 and 4.5, 1.0 and 4.2, 1.0 and 4.0, 1.0 and 3.0, 1.2 and 2.5, 1.5 and 2.5, 1.6 and 2.5, 1.7 and 2.5, 1.8 and 2.5, 1.9 and 2.5, 2.0 and 2.5, 2.1 and 2.5, 2.2 and 2.5, 2.3 and 2.5, 2.4 and 2.5, 1.2 and 2.4, 1.5 and 2.4, 1.6 and 2.4, 1.7 and 2.4, 1.8 and 2.4, 1.9 and 2.4, 2.0 and 2.4, 2.1 and 2.4, 2.2 and 2.4, 2.3 and 2.4, 1.2 and 2.3, 1.5 and 2.3, 1.6 and 2.3, 1.7 and 2.3, 1.8 and 2.3, 1.9 and 2.3, 2.0 and 2.3, 2.1 and 2.3, 2.2 and 2.3, 1.2 and 2.2, 1.5 and 2.52 1.6 and 2.2, 1.7 and 2.2, 1.8 and 2.2, 1.9 and 2.2, 2.0 and 2.2, 2.1 and 2.2, 1.2 and 2.1, 1.5 and 2.1, 1.6 and 2.1, 1.7 and 2.1, 1.8 and 2.1, 1.9 and 2.1, 2.0 and 2.1, 1.2 and 2.0, 1.5 and 2.0, 1.6 and 2.0, 1.7 and 2.0, 1.8 and 2.0, 1.9 and 2.0, 1.2 and 1.9, 1.5 and 1.9, 1.6 and 1.9, 1.7 and 1.9, 1.8 and 1.9, 1.2 and 1.8, 1.5 and 1.8, 1.6 and 1.8, 1.7 and 1.8, 1.2 and 1.7, 1.5 and 1.7, 1.6 and 1.7, 1.2 and 1.6, 1.5 and 1.6, or 1.2 and 1.5. In some embodiments, the method 300 achieves a VCF of any of about 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0.

In some examples, the flow rate of the permeate stream may be adjusted to control the volumetric concentration factor by activating or deactivating one or more permeate control pumps provided on one or more of the one or more permeate lines downstream of the one or more permeate outlets. The permeate control pumps may include either or both of variable displacement pumps and fixed displacement pumps. As such, the permeate flow rate may be adjusted by activating or deactivating one of the pumps and/or by increasing or decreasing the displacement of a variable displacement pump. Alternatively or additionally, the flow rate of the permeate stream may be adjusted to control the volumetric concentration factor by opening or closing, partially or fully, one or more flow control valves provided on one or more permeate lines downstream of the permeate outlets.

### Exemplary Computing Device

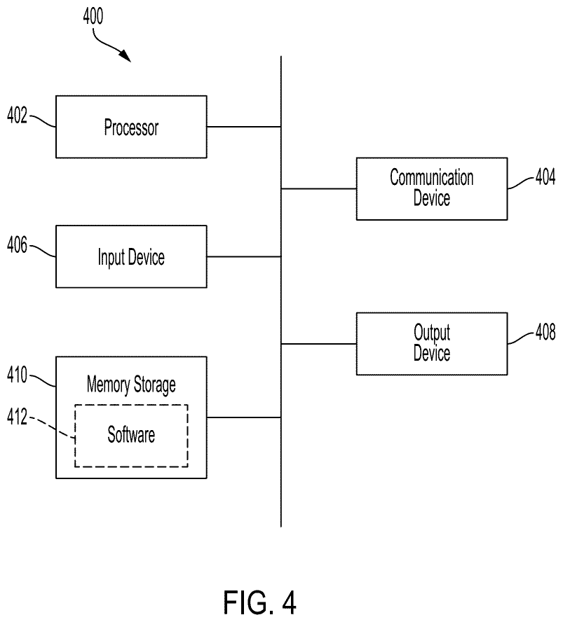

FIG. 4 depicts an exemplary computing device 400, which may be implemented in accordance with one or more examples of the disclosure. Device 400 can be a host computer connected to a network. Device 400 can be a client computer or a server. As shown in FIG. 4, device 400 can be any suitable type of microprocessor-based device, such as a personal computer, workstation, server, or handheld computing device (portable electronic device) such as a phone or tablet. The device can include, for example, one or more of processors 402, input device 406, output device 408, storage 410, and communication device 404. Input device 406 and output device 408 can generally correspond to those described above and can either be connectable or integrated with the computer.

Input device 406 can be any suitable device that provides input, such as a touch screen, keyboard or keypad, mouse, or voice-recognition device. Output device 408 can be any suitable device that provides output, such as a touch screen, haptics device, or speaker.

Storage 410 can be any suitable device that provides storage, such as an electrical, magnetic, or optical memory, including a RAM, cache, hard drive, or removable storage disk. Communication device 404 can include any suitable device capable of transmitting and receiving signals over a network, such as a network interface chip or device. The components of the computer can be connected in any suitable manner, such as via a physical bus or wirelessly.

Software 412, which can be stored in storage 410 and executed by processor 402, can include, for example, the programming that embodies the functionality of the present disclosure (e.g., as embodied in the devices as described above).

Software 412 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 410, that can contain or store programming for use by or in connection with an instruction execution system, apparatus, or device.

Software 412 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 400 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 400 can implement any operating system suitable for operating on the network. Software 412 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

### EXAMPLES

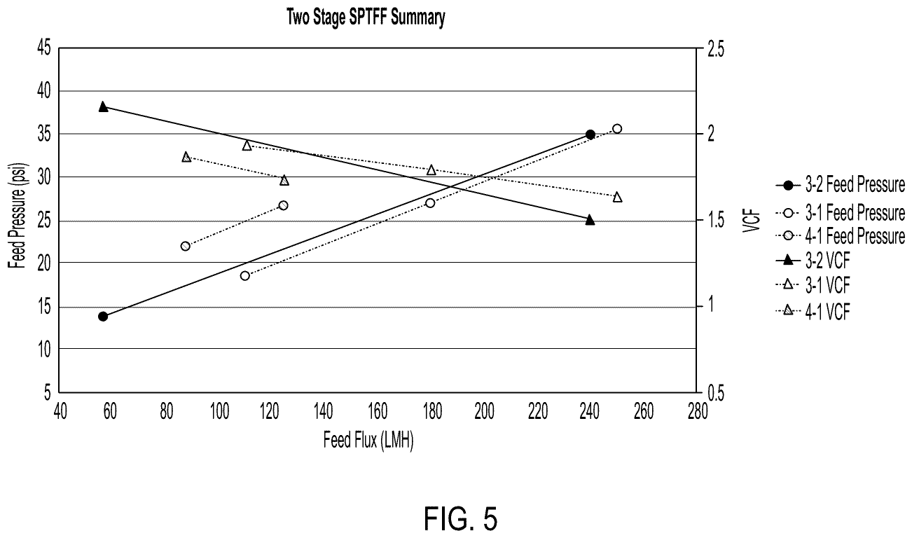

The exemplary SPTFF systems described herein can achieve a range of volumetric concentration factors while operating at relatively low pressures (e.g., compared to conventional systems) while utilizing only one or two filtration stages. FIGS. 5-9 illustrate testing data obtained using exemplary embodiments of the systems and methods disclosed herein.

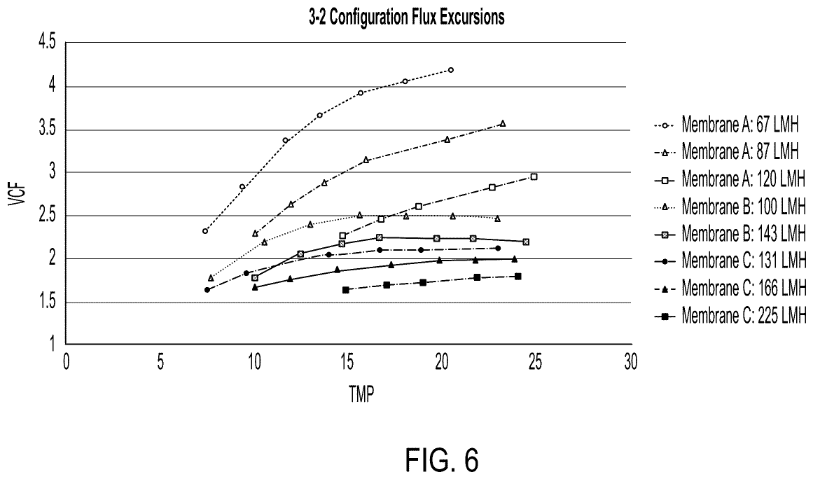

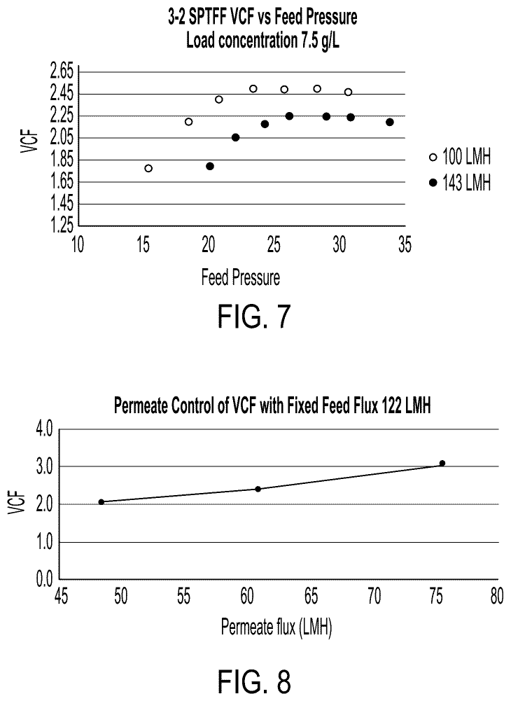

FIG. 5 illustrates capabilities of exemplary two-stage configurations to concentrate load material in a single pass. FIG. 5 specifically plots feed pressure (psi) and VCF against feed flux (LMH) for three different membrane configurations: 3:1, 3:2, and 4:1 membrane configurations. As shown, as feed flux increases, feed pressure increases and volumetric concentration factors decrease as a result of reduced retention time in the system. FIG. 6 illustrates the VCF capabilities of different membranes arranged in a 3:2 membrane configuration. The two-stage 3:2 membrane configuration is capable of concentrating to a VCF greater than 4× dependent on selected parameters, including feed flux and membrane type. As shown, the 3:2 configuration enables wide range of VCFs across a corresponding range of feed fluxes. FIG. 7 illustrates an exemplary VCF range achieved by a two-stage 3:2 membrane configuration at two feed flux set points (100 LMH and 143 LMH) with low pressure drop (e.g., less than 20.0 psi) across the SPTFF system. A VCF of 2.5 was achieved with a feed flux of 100 LMH, 15.6 psi pressure drop, and feed pressure of 23.3 psi. A VCF of 2.25 was achieved with a feed flux of 143 LMH, 18.8 psi pressure drop, and a feed pressure of 26.1 psi.

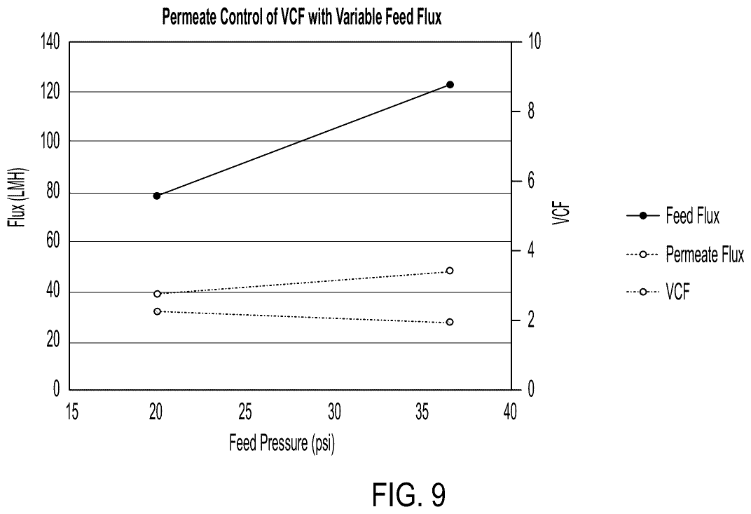

FIG. 8 illustrates an exemplary plot of VCF values achieved by controlling permeate flux using a flow control device on the permeate line under fixed feed flux conditions. As shown, VCF can be tuned to a desired concentration factor under fixed feed flux conditions by increasing or decreasing conversion to permeate across the SPTFF membranes. Increasing permeate flux using a pump, valve, or other flow control device on the permeate line(s) may induce an increase in VCF. FIG. 9 illustrates an exemplary plot of VCF values achieved by controlling permeate flux using a flow control device on the permeate line under variable feed flux conditions. As shown, VCF can be tuned to maintain a desired concentration factor under variable feed flux conditions by increasing or decreasing conversion to permeate across the SPTFF membranes.

### Exemplary Embodiments

1. A single pass tangential flow filtration system, the system comprising: a single pass tangential flow filtration unit configured to be fluidly connected to one or more preceding systems and one or more subsequent systems, wherein:

the single pass tangential flow filtration unit comprises one or more membranes or membrane devices in a one-or two-stage configuration, and a pressure drop across the one or more membranes or membrane devices is less than or equal to 30 psi.

2. The single pass tangential flow filtration system of embodiment 1, wherein the pressure drop across the one or more membranes or membrane devices is less than 20 psi.

3. The single pass tangential flow filtration system of any one of the preceding embodiments, wherein the single pass tangential flow filtration unit is configured to be connected to the one or more preceding systems by a feed flow inlet configured to receive a feed stream.

4. The single pass tangential flow filtration system of any one of the preceding embodiments, wherein the single pass tangential flow filtration unit is configured to be connected to the one or more subsequent systems by one or more retentate flow outlets each configured to output a retentate stream.

5. The single pass tangential flow filtration system of any one of the preceding embodiments, wherein the system is positioned on a mobile platform.

6. The single pass tangential flow filtration system of any one of embodiments 1-5, wherein no pump is provided between the single pass tangential flow filtration unit and the one or more preceding systems.

7. The single pass tangential flow filtration system of any one of embodiments 4-6, further comprising a controller in electrical communication with one or more sensors, the one or more sensors provided on a feed line in fluid communication with the feed flow inlet, one or more permeate lines in fluid communication with the one or more permeate outlets, and one or more retentate lines in fluid communication with the one or more retentate outlets.

8. The single pass tangential flow filtration system of embodiment 7, wherein the controller is configured to control a volumetric concentration factor based on a determined volumetric concentration factor.

9. The single pass tangential flow filtration system of embodiment 8, wherein the volumetric concentration factor is determined based on a reading from a first sensor and a second sensor of the one or more sensors.

10. The single pass tangential flow filtration system of embodiment 9, wherein the first sensor is a flow meter provided on the feed line in fluid communication with the feed flow inlet and the second sensor is a flow meter provided a retentate flow line of one or more retentate flow lines in fluid communication with one or more of the retentate outlets.

11. The single pass tangential flow filtration system of any one of embodiments 9-10, wherein the volumetric concentration factor is determined based upon a ratio of a measured flow rate of the feed stream to a measured flow rate of the retentate stream, wherein the respective flow rates are measured by the first and second sensors.

12. The single pass tangential flow filtration system of embodiment 9, wherein the first sensor is a protein concentration sensor provided on the feed line in fluid communication with the feed flow inlet and the second sensor is a protein concentration sensor provided a retentate flow line of one or more retentate flow lines in fluid communication with one or more of the retentate outlets, and wherein the volumetric concentration factor is determined based upon a ratio of a measured protein concentration of the retentate stream to a measured protein concentration of the feed stream, wherein the respective protein concentrations are measured by the first and second sensors.

13. The single pass tangential flow filtration system of any one of embodiments 8-12, wherein controlling the volumetric concentration factor comprises:

in accordance with determining that the volumetric concentration factor is outside of a threshold range based on the determined volumetric concentration factor, adjusting a flow rate of the permeate stream to bring the volumetric concentration factor within the threshold range.

14. The single pass tangential flow filtration system of embodiment 13, wherein the threshold range is between 1.0 and 3.0, including 1.0 and 3.0.

15. The single pass tangential flow filtration system of any one of embodiments 13-14, wherein the threshold range is between 1.5 and 2.5, including 1.5 and 2.5.

16. The single pass tangential flow filtration system of any one of embodiments 13-15, wherein adjusting a flow rate of the permeate stream to bring the volumetric concentration factor within the threshold range: comprises: activating or deactivating one or more permeate control pumps provided on one or more of the one or more permeate lines downstream of the one or more permeate outlets.

17. The single pass tangential flow filtration system of embodiment 16, wherein one or more of the permeate control pumps include one or more variable displacement pumps.

18. The single pass tangential flow filtration system of embodiment 17, wherein adjusting a flow rate of the permeate stream to bring the volumetric concentration factor within the threshold range comprises increasing a displacement of a variable displacement pump of the one or more variable displacement pumps.

19. The single pass tangential flow filtration system of any one of embodiments 17-18, wherein adjusting a flow rate of the permeate stream to bring the volumetric concentration factor within the threshold range comprises decreasing a displacement of a variable displacement pump of the one or more variable displacement pumps.

20. The single pass tangential flow filtration system of any one of embodiments 16-19, wherein one or more of the permeate control pumps include one or more fixed displacement pumps.

21. The single pass tangential flow filtration system of any one of embodiments 13-20, wherein adjusting a flow rate of the permeate stream to bring the volumetric concentration factor within the threshold range comprises: adjusting a valve provided on one or more permeate lines downstream of the one or more permeate outlets.

22. The single pass tangential flow filtration system of embodiment 21, wherein adjusting the valve comprises opening the valve.

23. The single pass tangential flow filtration system of any one of embodiments 21-22, wherein adjusting the valve comprises closing the valve.

24. The single pass tangential flow filtration system of any one of embodiments 7-23, wherein the one or more sensors comprise a flow meter, a pressure sensor, a temperature sensor, and a protein concentration sensor.

25. The single pass tangential flow filtration system of any one of the preceding embodiments, wherein the single pass tangential flow filtration unit comprises one or more membranes or membrane devices in a one stage configuration.

26. The single pass tangential flow filtration system of embodiment 25, wherein the one stage configuration is configured to receive a feed stream from the feed flow inlet and separate the feed stream into a retentate stream and a permeate stream by allowing a portion of the feed stream to pass through one or more membranes or membrane devices, the portion passing through the one or more membranes or membrane devices forming the permeate stream.

27. The single pass tangential flow filtration system of any one of embodiments 1-24, wherein the single pass tangential flow filtration unit comprises one or more membranes or membrane devices in a two-stage configuration.

28. The single pass tangential flow filtration system of embodiments 27, wherein the two-stage configuration is configured to receive a feed stream from the feed flow inlet and separate the feed stream into a retentate stream and a permeate stream by allowing a portion of the feed stream to pass through one or more membranes or membrane devices of a first stage and one or more membranes or membrane devices of a second filtration stage, the portion passing through the one or more membranes of the first and second stage forming the permeate stream.

29. The single pass tangential flow filtration system of any one of embodiments 3-28, wherein the operating temperature of the feed stream is between 2 degrees Celsius and 30 degrees Celsius, including 2 degrees Celsius and 30 degrees Celsius.

30. The single pass tangential flow filtration system of any one of embodiments 3-28, wherein the operating temperature of the feed stream is less than or equal to 20 degrees Celsius.

31. The single pass tangential flow filtration system of any one of embodiments 3-28,wherein the operating temperature of the feed stream is less than or equal to 15 degrees Celsius.

32. The single pass tangential flow filtration system of any one of embodiments 3-28,wherein the operating temperature of the feed stream is less than or equal to 10 degrees Celsius.

33. The single pass tangential flow filtration system of any one of embodiments 3-28,wherein the operating temperature of the feed stream is less than or equal to 5 degrees Celsius.

34. The single pass tangential flow filtration system of any one of embodiments 3-28, wherein the operating temperature of the feed stream is between 1 degree Celsius and 3 degrees Celsius, including 1 degree Celsius and 3 degrees Celsius.

35. The single pass tangential flow filtration system of any one of the preceding embodiments, wherein the one or more preceding systems comprise a purification system or a harvest system.

36. The single pass tangential flow filtration system of embodiment 35, wherein the purification system comprises a viral filtration system.

37. The single pass tangential flow filtration system of any one of embodiments 35-36, wherein the purification system comprises a chromatography system.

38. The single pass tangential flow filtration system of any one of embodiments 35-37, wherein the purification system comprises a diafiltration system.

39. The single pass tangential flow filtration system of any one of embodiments 35-38,wherein the purification system comprises an ultrafiltration system.

40. The single pass tangential flow filtration system of any one of the preceding embodiments, wherein the one or more subsequent systems comprise a purification system.

41. The single pass tangential flow filtration system of embodiment 40, wherein the purification system comprises a viral filtration system.

42. The single pass tangential flow filtration system of any one of embodiments 40-41, wherein the purification system comprises a chromatography system.

43. The single pass tangential flow filtration system of any one of embodiments 40-42, wherein the purification system comprises a diafiltration system.

44. The single pass tangential flow filtration system of any one of claims 40-43, wherein the purification system comprises an ultrafiltration system.

45. The single pass tangential flow filtration system of any one of embodiments 3-44, wherein the feed flow comprises a polypeptide preparation.

46. The single pass tangential flow filtration system of embodiment 45, wherein the polypeptide preparation comprises a polypeptide and one or more impurities.

47. A single pass tangential flow filtration method, the method comprising:
receiving a feed flow at a feed flow inlet of a single pass tangential flow filtration unit, wherein the single pass tangential flow filtration unit comprises one or more membranes or membrane devices in a one-or two-stage configuration, and wherein a pressure drop across the one or more membranes or membrane devices is less than or equal to 30 psi;
separating, using the one or more membranes or membrane devices, the feed stream into a permeate stream and a retentate stream; and
outputting the permeate stream through one or more permeate outlets and the retentate stream through one or more retentate outlets.

48. The method of embodiment 47, wherein the pressure drop across the one or more membranes or membrane devices is less than 20 psi.

49. The method of any one of the preceding embodiments, wherein the single pass tangential flow filtration unit is configured to be connected to the one or more preceding systems by a feed flow inlet configured to receive a feed stream.

50. The method of any one of the preceding embodiments, wherein the single pass tangential flow filtration unit is configured to be connected to the one or more subsequent systems by one or more retentate flow outlets each configured to output a retentate stream.

51. The method of any one of the preceding embodiments, wherein the single pass tangential flow filtration unit is positioned on a mobile platform.

52. The method of any one of embodiments 47-51, wherein no pump is provided between the single pass tangential flow filtration unit and the one or more preceding systems.

53. The method of any one of embodiments 50-52 wherein an exemplary system performing the method comprises a controller in electrical communication with one or more sensors, the one or more sensors provided on a feed line in fluid communication with the feed flow inlet, one or more permeate lines in fluid communication with the one or more permeate outlets, and one or more retentate lines in fluid communication with the one or more retentate outlets.

54. The method of any one of the preceding embodiments, the method further comprises controlling a volumetric concentration factor based on a determined volumetric concentration factor.

55. The method of embodiment 54, wherein the volumetric concentration factor is determined based on a reading from a first sensor and a second sensor of the one or more sensors.

56. The method of embodiment 55, wherein the first sensor is a flow meter provided on the feed line in fluid communication with the feed flow inlet and the second sensor is a flow meter provided a retentate flow line of one or more retentate flow lines in fluid communication with one or more of the retentate outlets.

57. The method of any one of embodiments 55-56, wherein the volumetric concentration factor is determined based upon a ratio of a measured flow rate of the feed stream to a measured flow rate of the retentate stream, wherein the respective flow rates are measured by the first and second sensors.

58. The method of embodiment 55, wherein the first sensor is a protein concentration sensor provided on the feed line in fluid communication with the feed flow inlet and the second sensor is a protein concentration sensor provided a retentate flow line of one or more retentate flow lines in fluid communication with one or more of the retentate outlets, and wherein the volumetric concentration factor is determined based upon a ratio of a measured protein concentration of the retentate stream to a measured protein concentration of the feed stream, wherein the respective protein concentrations are measured by the first and second sensors.

59. The method of any one of embodiments 54-58, wherein controlling the volumetric concentration factor comprises: in accordance with determining that the volumetric concentration factor is outside of a threshold range based on the determined volumetric concentration factor, adjusting a flow rate of the permeate stream to bring the volumetric concentration factor within the threshold range.

60. The method of embodiment 59, wherein the threshold range is between 1.0 and 3.0, including 1.0 and 3.0.

61. The method of any one of embodiments 59-60, wherein the threshold range is between 1.5 and 2.5, including 1.5 and 2.5.

62. The method of any one of embodiments 59-61, wherein adjusting a flow rate of the permeate stream to bring the volumetric concentration factor within the threshold range comprises: activating or deactivating one or more permeate control pumps provided on one or more of the one or more permeate lines downstream of the one or more permeate outlets.

63. The method of embodiment 62, wherein one or more of the permeate control pumps include one or more variable displacement pumps.

64. The method of embodiment 63, wherein adjusting a flow rate of the permeate stream to bring the volumetric concentration factor within the threshold range comprises increasing a displacement of a variable displacement pump of the one or more variable displacement pumps.

65. The method of any one of embodiments 63-64, wherein adjusting a flow rate of the permeate stream to bring the volumetric concentration factor within the threshold range comprises decreasing a displacement of a variable displacement pump of the one or more variable displacement pumps.

66. The method of any one of embodiments 62-65, wherein one or more of the permeate control pumps include one or more fixed displacement pumps.

67. The method of any one of embodiments 59-66, wherein adjusting a flow rate of the permeate stream to bring the volumetric concentration factor within the threshold range comprises: adjusting a valve provided on one or more permeate lines downstream of the one or more permeate outlets.

68. The method of embodiment 67, wherein adjusting the valve comprises opening the valve.

69. The method of any one of embodiments 67-68, wherein adjusting the valve comprises closing the valve.

70. The method of any one of embodiments 53-69, wherein the one or more sensors comprise a flow meter, a pressure sensor, a temperature sensor, and a protein concentration sensor.

71. The method of any one of embodiments 47-70, wherein the single pass tangential flow filtration unit comprises one or more membranes or membrane devices in a one stage configuration.

72. The method of embodiment 71, wherein the method further comprises receiving, by the one stage configuration, a feed stream from the feed flow inlet and separating the feed stream into a retentate stream and a permeate stream by allowing a portion of the feed stream to pass through one or more membranes or membrane devices, the portion passing through the one or more membranes or membrane devices forming the permeate stream.

73. The method of any one of embodiments 47-70, wherein the single pass tangential flow filtration unit comprises one or more membranes or membrane devices in a two-stage configuration.

74. The method of embodiment 73, wherein the method further comprises receiving by the two-stage configuration, a feed stream from the feed flow inlet and separating the feed stream into a retentate stream and a permeate stream by allowing a portion of the feed stream to pass through one or more membranes or membrane devices of a first stage and one or more membranes or membrane devices of a second filtration stage, the portion passing through the one or more membranes of the first and second stage forming the permeate stream.

75. The method of any one of embodiments 49-74, wherein the operating temperature of the feed stream is between 2 degrees Celsius and 30 degrees Celsius, including 2 degrees Celsius and 30 degrees Celsius.

76. The method of any one of embodiments 49-74, wherein the operating temperature of the feed stream is less than or equal to 20 degrees Celsius.

77. The method of any one of embodiments 49-74, wherein the operating temperature of the feed stream is less than or equal to 15 degrees Celsius.

78. The method of any one of embodiments 49-74, wherein the operating temperature of the feed stream is less than or equal to 10 degrees Celsius.

79. The method of any one of embodiments 49-74, wherein the operating temperature of the feed stream is less than or equal to 5 degrees Celsius.

80. The method of any one of embodiments 49-74, wherein the operating temperature of the feed stream is between 1 degree Celsius and 3 degrees Celsius, including 1 degree Celsius and 3 degrees Celsius.

81. The method of any one of embodiments 47-80, wherein the one or more preceding systems comprise a purification system or a harvest system.

82. The method of embodiment 81, wherein the purification system comprises a viral filtration system.

83. The method of any one of embodiments 81-82, wherein the purification system comprises a chromatography system.

84. The method of any one of embodiments 81-83, wherein the purification system comprises a diafiltration system.

85. The method of any one of embodiments 81-84, In some embodiments, the purification system comprises an ultrafiltration system.

86. The method of any one of embodiments 47-85, the one or more subsequent systems comprise a purification system.

87. The method of embodiment 86, wherein the one or more subsequent systems comprise a viral filtration system.

88. The method of any one of embodiments 86-87, wherein the one or more subsequent systems comprise a chromatography system.

89. The method of any one of embodiments 86-88, wherein the one or more subsequent systems comprise a diafiltration system.

90. The method of any one of embodiments 86-89, wherein the one or more subsequent systems comprise an ultrafiltration system.

91. The method of any one of embodiments 49-90, wherein the feed flow comprises a polypeptide preparation.

92. The method of embodiment 91, wherein he polypeptide preparation comprises a polypeptide and one or more impurities.

1. A single pass tangential flow filtration system, the system comprising:
a single pass tangential flow filtration unit configured to be fluidly connected to one or more preceding systems and one or more subsequent systems, wherein:
the single pass tangential flow filtration unit comprises one or more membranes or membrane devices in a one-or two-stage configuration, and a pressure drop across the one or more membranes or membrane devices is less than or equal to 30 psi.

2. The single pass tangential flow filtration system of claim 1, wherein the pressure drop across the one or more membranes or membrane devices is less than 20 psi.

3. The single pass tangential flow filtration system of claim 1, wherein the single pass tangential flow filtration unit is configured to be connected to the one or more preceding systems by a feed flow inlet configured to receive a feed stream.

4. The single pass tangential flow filtration system of claim 3, wherein the single pass tangential flow filtration unit is configured to be connected to the one or more subsequent systems by one or more retentate flow outlets each configured to output a retentate stream.

5. The single pass tangential flow filtration system of claim 1, wherein the system is positioned on a mobile platform.

6. The single pass tangential flow filtration system of claim 1, wherein no pump is provided between the single pass tangential flow filtration unit and the one or more preceding systems.

7. The single pass tangential flow filtration system of claim 4, further comprising a controller in electrical communication with one or more sensors, the one or more sensors provided on a feed line in fluid communication with the feed flow inlet, one or more permeate lines in fluid communication with the one or more permeate outlets, and one or more retentate lines in fluid communication with the one or more retentate outlets.

8. The single pass tangential flow filtration system of claim 7, wherein the controller is configured to control a volumetric concentration factor based on a determined volumetric concentration factor.

9. The single pass tangential flow filtration system of claim 8, wherein the volumetric concentration factor is determined based on a reading from a first sensor and a second sensor of the one or more sensors.

10. The single pass tangential flow filtration system of claim 9, wherein the first sensor is a flow meter provided on the feed line in fluid communication with the feed flow inlet and the second sensor is a flow meter provided a retentate flow line of one or more retentate flow lines in fluid communication with one or more of the retentate outlets.

11. The single pass tangential flow filtration system of claim 9, wherein the volumetric concentration factor is determined based upon a ratio of a measured flow rate of the feed stream to a measured flow rate of the retentate stream, wherein the respective flow rates are measured by the first and second sensors.

12. The single pass tangential flow filtration system of claim 9, wherein the first sensor is a protein concentration sensor provided on the feed line in fluid communication with the feed flow inlet and the second sensor is a protein concentration sensor provided a retentate flow line of one or more retentate flow lines in fluid communication with one or more of the retentate outlets, and wherein the volumetric concentration factor is determined based upon a ratio of a measured protein concentration of the retentate stream to a measured protein concentration of the feed stream, wherein the respective protein concentrations are measured by the first and second sensors.

13. The single pass tangential flow filtration system of claim 8, wherein controlling the volumetric concentration factor comprises:
in accordance with determining that the volumetric concentration factor is outside of a threshold range based on the determined volumetric concentration factor, adjusting a flow rate of the permeate stream to bring the volumetric concentration factor within the threshold range.

14. The single pass tangential flow filtration system of claim 13, wherein the threshold range is between 1.0 and 3.0, including 1.0 and 3.0.

15. The single pass tangential flow filtration system of claim 13, wherein the threshold range is between 1.5 and 2.5, including 1.5 and 2.5.

16. The single pass tangential flow filtration system of claim 13, wherein adjusting a flow rate of the permeate stream to bring the volumetric concentration factor within the threshold range comprises: activating or deactivating one or more permeate control pumps provided on one or more of the one or more permeate lines downstream of the one or more permeate outlets.

17. The single pass tangential flow filtration system of claim 16, wherein one or more of the permeate control pumps include one or more variable displacement pumps.

18. The single pass tangential flow filtration system of claim 17, wherein adjusting a flow rate of the permeate stream to bring the volumetric concentration factor within the threshold range comprises increasing a displacement of a variable displacement pump of the one or more variable displacement pumps.

19. The single pass tangential flow filtration system of claim 17, wherein adjusting a flow rate of the permeate stream to bring the volumetric concentration factor within the threshold range comprises decreasing a displacement of a variable displacement pump of the one or more variable displacement pumps.

20. The single pass tangential flow filtration system of claim 16, wherein one or more of the permeate control pumps include one or more fixed displacement pumps.

21. The single pass tangential flow filtration system of claim 13, wherein adjusting a flow rate of the permeate stream to bring the volumetric concentration factor within the threshold range comprises: adjusting a valve provided on one or more permeate lines downstream of the one or more permeate outlets.

22. The single pass tangential flow filtration system of claim 21, wherein adjusting the valve comprises opening the valve.

23. The single pass tangential flow filtration system of claim 21, wherein adjusting the valve comprises closing the valve.

24. The single pass tangential flow filtration system of claim 7, wherein the one or more sensors comprise a flow meter, a pressure sensor, a temperature sensor, and a protein concentration sensor.

25. The single pass tangential flow filtration system of claim 1, wherein the single pass tangential flow filtration unit comprises one or more membranes or membrane devices in a one stage configuration.

26. The single pass tangential flow filtration system of claim 25, wherein the one stage configuration is configured to receive a feed stream from the feed flow inlet and separate the feed stream into a retentate stream and a permeate stream by allowing a portion of the feed stream to pass through one or more membranes or membrane devices, the portion passing through the one or more membranes or membrane devices forming the permeate stream.

27. The single pass tangential flow filtration system of claim 1, wherein the single pass tangential flow filtration unit comprises one or more membranes or membrane devices in a two-stage configuration.

28. The single pass tangential flow filtration system of claim 27, wherein the two-stage configuration is configured to receive a feed stream from the feed flow inlet and separate the feed stream into a retentate stream and a permeate stream by allowing a portion of the feed stream to pass through one or more membranes or membrane devices of a first stage and one or more membranes or membrane devices of a second filtration stage, the portion passing through the one or more membranes of the first and second stage forming the permeate stream.

29. The single pass tangential flow filtration system claim 3 wherein the operating temperature of the feed stream is between 2 degrees Celsius and 30 degrees Celsius, including 2 degrees Celsius and 30 degrees Celsius.

30. The single pass tangential flow filtration system of claim 3, wherein the operating temperature of the feed stream is less than or equal to 20 degrees Celsius.

31. The single pass tangential flow filtration system of claim 3, wherein the operating temperature of the feed stream is less than or equal to 15 degrees Celsius.

32. The single pass tangential flow filtration system of claim 3, wherein the operating temperature of the feed stream is less than or equal to 10 degrees Celsius.

33. The single pass tangential flow filtration system of claim 3, wherein the operating temperature of the feed stream is less than or equal to 5 degrees Celsius.

34. The single pass tangential flow filtration system of claim 3, wherein the operating temperature of the feed stream is between 1 degree Celsius and 3 degrees Celsius, including 1 degree Celsius and 3 degrees Celsius.

35. The single pass tangential flow filtration system of claim 1, wherein the one or more preceding systems comprise a purification system or a harvest system.

36. The single pass tangential flow filtration system of claim 35, wherein the purification system comprises a viral filtration system.

37. The single pass tangential flow filtration system of claim 35, wherein the purification system comprises a chromatography system.

38. The single pass tangential flow filtration system of claim 35, wherein the purification system comprises a diafiltration system.

39. The single pass tangential flow filtration system of claim 35, wherein the purification system comprises an ultrafiltration system.

40. The single pass tangential flow filtration system of claim 1, wherein the one or more subsequent systems comprise a purification system.

41. The single pass tangential flow filtration system of claim 40, wherein the purification system comprises a viral filtration system.

42. The single pass tangential flow filtration system of claim 40, wherein the purification system comprises a chromatography system.

43. The single pass tangential flow filtration system of claim 40, wherein the purification system comprises a diafiltration system.

44. The single pass tangential flow filtration system of claim 40, wherein the purification system comprises an ultrafiltration system.

45. The single pass tangential flow filtration system of claim 3, wherein the feed flow comprises a polypeptide preparation.

46. The single pass tangential flow filtration system of claim 45, wherein the polypeptide preparation comprises a polypeptide and one or more impurities.

47. A single pass tangential flow filtration method, the method comprising:
receiving a feed flow at a feed flow inlet of a single pass tangential flow filtration unit, wherein the single pass tangential flow filtration unit comprises one or more membranes or membrane devices in a one-or two-stage configuration, and wherein a pressure drop across the one or more membranes or membrane devices is less than or equal to 30 psi;
separating, using the one or more membranes or membrane devices, the feed stream into a permeate stream and a retentate stream; and
outputting the permeate stream through one or more permeate outlets and the retentate stream through one or more retentate outlets.
